(19) United States
(12) Patent Application Publication
(10) Pub. No.: US 2013/0302618 A1
(43) Pub. Date: Nov. 14, 2013

(54) HIGH-STRENGTH ALKALI-ALUMINOSILICATE GLASS

(71) Applicants: Bernd Kuhnemann, Weisswasser (DE); Michael Boettger, Taipei (TW); Sicco Rathke, Ahlerstedt-Klein Wangersen (DE)

(72) Inventors: Bernd Kuhnemann, Weisswasser (DE); Michael Boettger, Taipei (TW); Sicco Rathke, Ahlerstedt-Klein Wangersen (DE)

(73) Assignee: Kornerstone Materials Technology Co., Ltd., Fuzhou, Fujian (CN)

(21) Appl. No.: 13/980,258

(22) PCT Filed: Jan. 27, 2012
(86) PCT No.: PCT/EP12/51247

§ 371 Date: Jul. 17, 2013

(30) Foreign Application Priority Data
Jan. 28, 2011 (DE) 102011009769.4

(51) Int. Cl. C03C 3/091; C03C 3/085; C03C 3/087; C03C 21/00

(52) U.S. Cl. CPC C03C 3/091; C03C 21/002; C03C 3/085; C03C 3/087
USPC 428/410; 65/30.14; 501/66; 501/69; 501/70

(57) ABSTRACT

A high-strength alkali-aluminosilicate glass, characterized by excellent meltability, fineability. and processibility, exhibits the following formula: SiO₂ 60.5 to 69.0 weight percent Al₂O₃ 7.0 to 11.8 weight percent B₂O₃ 0 to 4.0 weight percent MgO 2.0 to 8.5 weight percent CaO 0 to 4.0 weight percent ZnO 0 to 5.0 weight percent ZrO₂ 0 to 3.0 weight percent Na₂O 15.0 to 17.5 weight percent K₂O 0 to 2.7 weight percent Li₂O 0 to 2.0 weight percent and from 0 to 1.5 weight percent of a fining agents such as As₂O₃, Sb₂O₃ CeO₂, SnO₂, Cl⁻, F⁻, (SO₄)²⁻ and combinations thereof. The glass allows for adequate conditions for an alkali ion exchange treatment in a short time period (4 to 8 hours) and can also be produced according to the established, continuous, vertically downward directed drawing process such as the overflow down-draw method or the fusion method, the die slot or the slot down-draw method, or combinations thereof. The viscosity temperature profile of these glasses allows the use of conventional fining agents in combination at the lowest amounts possible and additionally allows the production of glasses that are free of or contain only small amounts of either or both of antimony oxide and arsenic oxide.

### FIELD OF THE INVENTION

The present invention relates to a high-strength alkali-aluminosilicate glass, a method for manufacturing the high-strength alkali-aluminosilicate glass and applications and uses for the high-strength alkali-aluminosilicate glass.

### BACKGROUND

The recent growth in the popularity and use of mobile computing and communication devices has generated a demand for cover glass (protective glass) for touch panels, for protecting a display and for improving the appearance of such devices. Due to the desire for such devices to be small and lightweight, the cover glass used in such devices has to be as thin and lightweight as possible. Consequently, the need has arisen to manufacture cover glass that meets these requirements yet retains sufficient durability to not easily crack or break when the device is dropped by a user as well as being extremely scratch-resistant. Such conflicting demands have made it highly desirable to increase the strength of such cover glass.

One such process for strengthening glass is based on the generation of a compression stress layer in the surface of the glass. The generation of the compression stress layer can be accomplished by physical or chemical methods. A physical process for generating a compression stress layer involves heating the glass to a temperature above the transformation temperature followed by rapid cooling. According to this physical process, a large compression stress layer is generated so that the physical process for generating a compression stress layer is not applicable for thin glass (less than 3 mm), such as cover glass.

Among the chemical processes for strengthening glass, an ion exchange process that takes place at a temperature below the strain point of the glass, has proven to be particularly practical. According to such a process, small alkali-ions from the glass are exchanged for larger ions from an ion source, preferably molten salt or another ion source, such as a surface coating. Typically, the sodium ions of the glass are replaced by potassium ions from a potassium nitrate melt. The resulting compression stress layer has high compressive stress values and extends across a thin layer near the surface of the glass. The required compressive stress intensity and the required depth of the compression stress layer depend upon the requirements related to the intended use of the glass as well as the manufacturing technique or process-related properties of the same.

The efficiency of the ion exchange strengthening process is highly dependent on the composition of the glass. The reason for this is that the mobility of the alkali ions is highly dependent upon their structural integration into the glass network. It is known that compared to other glass systems, alkali-aluminosilicate glasses are particularly well-suited for the ion exchange strengthening process when they contain alkaline earth and other oxide additives. The good sodium diffusion in alkali-aluminosilicate glasses is explained by the fact that the sodium ions are likely to bind to the tetrahedral AlO₄ group because of an expected lower binding energy value due to a larger distance to the oxygen atom compared to binding to SiO₄ tetrahedrons of other glass systems.

Alkali-aluminosilicate glasses also allow a high diffusion rate of ions as a prerequisite for short treatment times and high compression stresses can build up near the surface of such glasses. Short treatment times are desirable for economical reasons.

In order to manufacture such alkali-aluminosilicate glasses using conventional melt processing equipment and technology, additional oxides must be added so as to produce glass having the desired properties of high-strength, scratch resistance and resistance to breakage.

Due to the high demands on the surface quality of display glass, such as cover glass, it is highly desirable to utilize special methods of forming the glass by drawing the glass from the glass melt which methods produce glass having sufficiently superior surface quality such that the need for surface treatments such as grinding and polishing is minimized.

Such special drawing methods include, the overflow down-draw method or the fusion method, the die slot or the slot down-draw method, or combinations thereof. Such methods will be collectively referred to herein as “the down-draw methods” and are disclosed in German Patent No. DE 1 596 484, German Patent No. DE 1 201 956, U.S. Pat. No. 3,338,696, and U.S. Patent Application Publication No. US 2001/0038929 A1.

The down-draw methods require that the glass composition also meet the following requirements:
1. The glass composition must be suitable for processing according to the down-draw methods. To be suitable for processing according to the down-draw methods, it is essential that the glass composition does not crystallize in the processing temperature range. This can only be ensured if the viscosity of the glass at the liquidus temperature (the temperature at which the glass crystallizes) is higher than the maximum drawing viscosity.
2. Certain requirements of the glass arise from the melting and fining processes. Such requirements entail economic considerations, such as energy requirements and the durability of the components, as well as workplace and environmental safety and hazard concerns especially when toxic or hazardous raw materials are used to enhance the melting and fining processes. The goal is to use a fining agent system which is largely environmentally neutral.

U.S. Pat. No. 7,666,511 B2 discloses a glass composition that is alleged to be suitable for chemical strengthening by ion exchange and that can be downdrawn into sheets by various down-draw processes, such as the fusion and slot down-draw methods.

U.S. Patent Application Publication No. 2010/0087307 A1 discloses a glass composition, which largely overlaps the glass composition ranges disclosed in U.S. Pat. No. 7,666,511 B2. The described glass composition is said to be suitable for a variety of flat glass processing techniques, such as the down-draw methods as well as for laminated glass (horizontal by rolling shaped flat glass), the Fourcault method (vertically-drawn flat glass in which the glass is drawn against gravity in an upward direction), and the so-called redraw method, in which a thicker mother glass is brought to the desired (thin) wall thickness by means of sectional heating and drawing forces that are directed vertically downwards.

However, there are disadvantages and drawbacks to the alkali-aluminosilicate glass compositions disclosed in U.S. Pat. No. 7,666,511 B2 and U.S. Patent Application Publication No. 2010/0087307 A1. Specifically, while the compositions may be maximized for the ion exchange strengthening process, the high viscosity of such glasses makes them relatively difficult to melt. In addition, the high viscosity of such alkali-aluminosilicate glasses significantly reduces the applicability of classical fining agents, because the fining (removal of gas bubbles) temperatures of such glasses are generally above the decomposition temperatures of such classical fining agents. It has thus become customary to use redox fining agents for the fining of alkali-aluminosilicate glasses, such as arsenic oxide (As₂O₃) and antimony oxide (Sb₂O₃) as they optimally deliver the oxygen required for the fining process at a temperature range of from 1,200° C. to about 1,530° C. A significantly higher dosage in the raw material mixture is required if these toxic redox fining agents are used at considerably higher temperatures for the fining process. For emission protection reasons as well as in view of the glass composition, which is desirably free from toxic compounds, it is desirable that the melting and fining of such glass compositions be accomplished without, or only with very minute quantities of, such typical redox fining agents.

U.S. Pat. No. 7,666,511 B2 and U.S. Patent Application Publication No. 2010/0087307 A1 both postulate that a rather high Al₂O₃ concentration improves the suitability of the disclosed glass compositions for chemical strengthening.

There are a variety of glass compositions that have been published by others related to alkali-aluminosilicate glasses, the object of which was chemical strengthening. However, these glass compositions do not take into account the requirements for the suitability of such glass compositions to the down-draw methods. For example, U.S. Patent Application Publication No. 2009/0298669 A1 also describes a strengthened glass composition, which may be used to form plate glass by the float process, down-draw process or press method. However, the liquidus viscosity was indicated to be at least 10⁴ dPa·s. Such a liquidus viscosity is too low to be successfully used in the down-draw methods.

### DESCRIPTION OF THE DRAWINGS

FIG. 1 illustrates a typical viscosity-temperature curve for the high-strength alkali-aluminosilicate glass described herein.

### DETAILED DESCRIPTION

A high-strength alkali-aluminosilicate glass is provided, which glass has improved production characteristics while maintaining sufficient strength properties.

According to one embodiment, the high-strength alkali-aluminosilicate glass has the following composition:

from 60.5 to 69.0 weight percent of silicon dioxide (SiO₂),

from 7.0 to 11.8 weight percent of aluminum (III) oxide (Al₂O₃),

from 0 to 4.0 weight percent of boron trioxide (B₂O₃),

from 2.0 to 8.5 weight percent of magnesium oxide (MgO),

from 0 to 4.0 weight percent of calcium oxide (CaO),

from 0 to 5.0 weight percent of zinc oxide (ZnO),

from 0 to 3.0 weight percent of zirconium dioxide (ZrO₂),

from 15.0 to 17.5 weight percent of sodium oxide (Na₂O),

from 0 to 2.7 weight percent of potassium oxide (K₂O),

from 0 to 2.0 weight percent of lithium oxide (Li₂O), and

from 0 to 1.50 weight percent of a fining agent such as arsenic oxide (As₂O₃), antimony oxide (Sb₂O₃), cerium oxide (CeO₂), tin (IV) oxide (SnO₂), chloride ion (Cl⁻), fluoride ion (F⁻), sulfate ion ((SO₄)²⁻) and combinations thereof.

According to another embodiment of the high-strength alkali-aluminosilicate glass described above, the glass comprises from 0 to 0.5 weight percent of As₂O₃ and Sb₂O₃. According to yet another embodiment the glass comprises less than 0.01 weight percent of As₂O₃ and Sb₂O₃, i.e. less than the detection threshold of the X-ray fluorescence analysis.

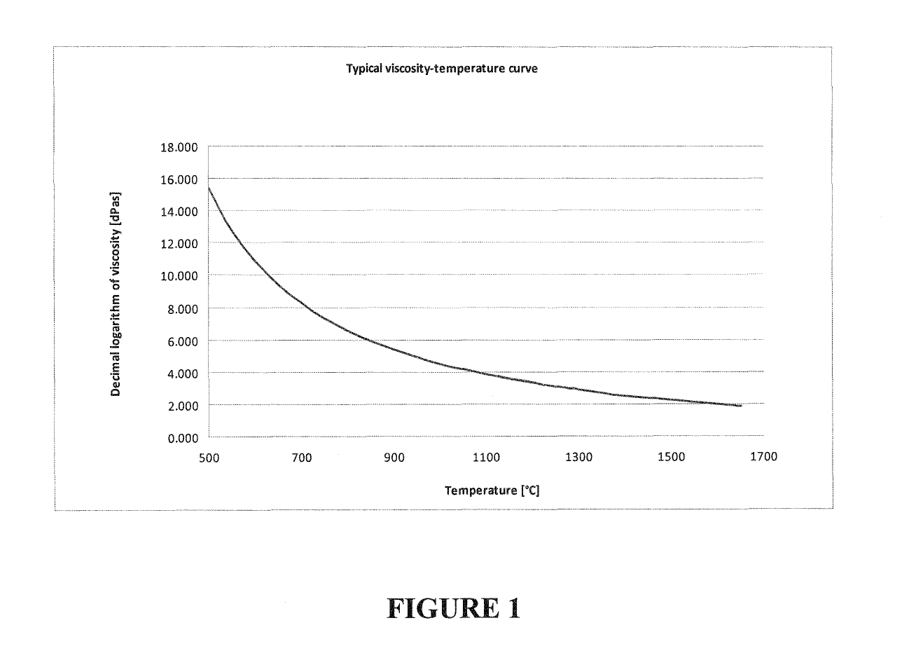

The high-strength alkali-aluminosilicate glass described above is characterized by excellent meltability, fineability and processability. The high-strength alkali-aluminosilicate glass described above allows for adequate conditions for an alkali ion exchange process in a short time period, such as from 4 to 8 hours. The high-strength alkali-aluminosilicate glass described above may be produced according to the down-draw methods. The viscosity-temperature curve of the high-strength alkali-aluminosilicate glass described above and shown in FIG. 1, also allows for the use of one or more non-toxic fining agents, such as CeO₂, SnO₂, Cl⁻, F⁻, (SO₄)²⁻, in small amounts thus allowing for the production of glasses free of or containing only small amounts of arsenic oxide and antimony oxide.

When taking into account additional technological devices and variants during the preparation of the high-strength alkali-aluminosilicate glass described above, the glass can be optimized with respect to its strength parameters such as surface compressive stress intensity and the depth of the compression stress layer as well as glass quality.

Particularly high depths of the compression stress layer and high surface compressive stress intensities are developed when the weight ratio of Al₂O₃ to SiO₂ in the high-strength alkali-aluminosilicate glass described above is greater than 0.11. As the weight ratio of Al₂O₃ to SiO₂ in the high-strength alkali-aluminosilicate glass described above increases, so do the depth of the compression stress layer and the intensity of the surface compressive stress. However, when the weight ratio of Al₂O₃ to SiO₂ in the high-strength alkali-aluminosilicate glass described above is greater than 0.195, such compositions are difficult to melt because the proportion of alkali oxides and alkaline earth oxide decreases when the SiO₂ content is at least 60.5 weight percent for reasons of chemical stability.

According to an embodiment of the high-strength alkali-aluminosilicate glass described above, SiO₂, Al₂O₃ and ZrO₂ are present in the composition in a combined amount of up to 81 weight percent in order to obtain a sufficiently adequate meltability. According to another embodiment of the high-strength alkali-aluminosilicate glass described above, SiO₂, Al₂O₃ and ZrO₂ are present in the composition in a combined amount of at least 70 weight percent in order to achieve a glass with sufficient stability. According to yet another embodiment of the high-strength alkali-aluminosilicate glass described above, SiO₂, Al₂O₃ and ZrO₂ are present in the composition in a combined amount of from 70 to 81 weight percent.

According to an embodiment of the high-strength alkali-aluminosilicate glass described above, particularly high compression stress layer depths and high surface compressive stress intensities are achieved when the weight ratio of Na₂O to Al₂O₃ is greater than 1.2. According to another embodiment of the high-strength alkali-aluminosilicate glass described above, the maximum value of the weight ratio of Na₂O to Al₂O₃ is 2.2 for reasons of chemical stability. According to yet another embodiment of the high-strength alkali-aluminosilicate glass described above, the weight ratio of Na₂O to Al₂O₃ is from 1.2 to 2.2.

According to an embodiment of the high-strength alkali-aluminosilicate glass described above, when the composition includes a combined total of at least 15.0 weight percent of Na₂O, K₂O, and Li₂O, the composition has excellent meltability and produces a glass with high compressive stress intensity and a high compression stress layer depth. According to another embodiment of the high-strength alkali-aluminosilicate glass described above, the composition includes a combined total of up to 20.5 weight percent of Na₂O, K₂O, and Li₂O, to ensure that the glass is adequately chemically resistant and that the coefficient of thermal expansion is not too high. According to yet another embodiment of the high-strength alkali-aluminosilicate glass described above, the composition includes a combined total of from 15.0 to 20.5 weight percent of Na₂O, K₂O, and Li₂O.

According to an embodiment of the high-strength alkali-aluminosilicate glass described above, the weight ratio of the combined total of SiO₂, Al₂O₃, and ZrO₂ to the combined total of Na₂O, K₂O, Li₂O and B₂O₃ is from 3.3 to 5.4. Such compositions have adequate melting and fining behavior along with high ion exchange rates.

According to an embodiment of the high-strength alkali-aluminosilicate glass described above, the composition includes from 3.0 to 7.0 weight percent of MgO. According to another embodiment of the high-strength alkali-aluminosilicate glass described above, the composition includes from 4.0 to 6.5 weight percent of MgO. Compositions including these ranges of MgO produced glasses with extremely good values regarding high compressive stress intensity and compression layer depths. Furthermore, the liquidus viscosity of such glasses is increased in an advantageous manner.

According to an embodiment of the high-strength alkali-aluminosilicate glass described above, the composition includes from 64.0 to 66.0 weight percent of SiO₂. Compositions including this range of SiO₂ have good hardening, meltability and fining properties.

According to an embodiment of the high-strength alkali-aluminosilicate glass described above, the composition includes from 8.0 to 10.0 weight percent of Al₂O₃.

According to an embodiment of the high-strength alkali-aluminosilicate glass described above, the composition includes up to 2.0 weight percent of CaO.

According to an embodiment of the high-strength alkali-aluminosilicate glass described above, the composition includes up to 2.0 weight percent of ZnO.

According to an embodiment of the high-strength alkali-aluminosilicate glass described above, the composition includes up to 2.5 weight percent of ZrO₂.

According to an embodiment of the high-strength alkali-aluminosilicate glass described above, it was found that the incorporation in the composition of up to 2.7 weight percent of K₂O had no significant influence on the depth of the compression stress layer. According to an embodiment of the high-strength alkali-aluminosilicate glass described above, the composition includes from 1.0 to 2.5 weight percent of K₂O.

A method for manufacturing a high-strength alkali-aluminosilicate glass is provided. According to an embodiment for manufacturing a high-strength alkali-aluminosilicate glass, the method includes:
a) mixing and melting the components to form a homogenous glass melt followed by fining of the glass melt;
b) shaping the glass using one of the down-draw methods; and
c) chemical strengthening of the glass by ion exchange.

The manufacture of the high-strength alkali-aluminosilicate glasses, may be carried out using established facilities for performing the down-draw methods, which customarily include a directly or indirectly heated precious metal system consisting of a homogenization device, a device to lower the bubble content by means of refining (refiner), a device for cooling and thermal homogenization, a distribution device and other devices.

According to an embodiment of the high-strength alkali-aluminosilicate glass described above, the melting temperature (Tₘₑₗₜ) of the glass at a viscosity of 10² dPa·s is less than 1,700° C. According to another embodiment of the high-strength alkali-aluminosilicate glass described above, the Tₘₑₗₜ of the glass at a viscosity of 10² dPa·s is less than 1,600° C. According to yet another embodiment of the high-strength alkali-aluminosilicate glass described above, the Tₘₑₗₜ of the glass at a viscosity of 10² dPa·s is less than 1,585° C.

According to an embodiment of the high-strength alkali-aluminosilicate glass described above, high quality glass in terms of the number and size of bubbles can be produced by using a refiner such as described in DE 10253222 B4 while using the smallest possible fining agent content at viscosities less than 10³ dPa·s. The design of such refiners enables glass melt compositions to be refined at temperatures of up to 1,650° C. However, when such refiners are used in connection with the manufacture of the high-strength alkali-aluminosilicate glass composition described above, the glass melt composition can be refined at temperatures of 1,600° C. at a viscosity of 10² dPa·s.

Consequently, using refiners of such design permits the manufacture of glasses that are low in or free from Sb₂O₃ and As₂O₃ and can be melted using the most varied known refining agents such as described in DE 197 39 912 C2 (such as SnO₂, CeO₂, Cl⁻, F⁻ and (SO₄)₂), which show an optimal effect when used with precious metal refiners at temperatures of 1,600° C. through 1,650° C.

According to an embodiment of the method for manufacturing a high-strength alkali-aluminosilicate glass described above, the ion exchange treatment is conducted for less than 12 hours. According to another embodiment of the method for manufacturing a high-strength alkali-aluminosilicate glass described above, the ion exchange treatment is conducted for less than 6 hours. According to yet another embodiment of the method for manufacturing a high-strength alkali-aluminosilicate glass described above, the ion exchange treatment is conducted for up to 4 hours. According to an embodiment of the method for manufacturing a high-strength alkali-aluminosilicate glass described above, within the first 4 to 6 hours of such ion exchange treatment, a compression stress layer having a depth of approximately 40 μm is developed. Consequently, the decrease in the depth of the compression stress layer due to relaxation caused by a long ion exchange treatment can be avoided.

According to an embodiment of the method for manufacturing a high-strength alkali-aluminosilicate glass described above, the ion exchange treatment takes place at a temperature range of 50 to 120 K below the transformation temperature Tg of the glass melt. In this manner, a reduction of the depth of the compression stress layer that is created by the ion exchange treatment is avoided.

According to an embodiment of the method for manufacturing a high-strength alkali-aluminosilicate glass described above, the ion exchange treatment process is conducted at an initial high temperature within the temperature range described above and then at a second lower temperature. According to such a method, a reduction in the depth of the compression stress layer that is created by the ion exchange treatment due to relaxation is avoided.

According to an embodiment of the high-strength alkali-aluminosilicate glass described above, the glass has a compressive stress at the surface thereof of at least 350 MPa. According to another embodiment of the high-strength alkali-aluminosilicate glass described above, the glass has a compressive stress at the surface thereof of at least 450 MPa. According to still another embodiment of the high-strength alkali-aluminosilicate glass described above, the glass has a compressive stress at the surface thereof of up to 600 MPa. According to yet another embodiment of the high-strength alkali-aluminosilicate glass described above, the glass has a compressive stress at the surface thereof of more than 650 MPa. According to another embodiment of the high-strength alkali-aluminosilicate glass described above, the glass has a compressive stress at the surface thereof of from 350 MPa to 650 MPa.

According to an embodiment of the high-strength alkali-aluminosilicate glass described above, the glass has a compression stress layer having a depth of at least 30 μm. According to another embodiment of the high-strength alkali-aluminosilicate glass described above, the glass has a compression stress layer having a depth of at least 50 μm. According to yet another embodiment of the high-strength alkali-aluminosilicate glass described above, the glass has a compression stress layer having a depth of up to 100 μm. According to still another embodiment of the high-strength alkali-aluminosilicate glass described above, the glass has a compression stress layer having a depth of from 30 μm to 100 μm.

The down-draw methods for shaping the glass require that no crystallization (devitrification) occurs while the glass is being shaped. The liquidus temperature of a glass is the temperature at which there is thermodynamic equilibrium between the crystal and melt phases of the glass. When the glass is held at a temperature above the liquidus temperature, no crystallization is possible. According to an embodiment of the high-strength alkali-aluminosilicate glass described above, the glass has a liquidus temperature of up to 900° C. According to another embodiment of the high-strength alkali-aluminosilicate glass described above, the glass has a liquidus temperature of up to 850° C.

According to an embodiment of the high-strength alkali-aluminosilicate glass described above, the sink-in-point or working point (T_{work}) (viscosity 10⁴ dPa·s) of the glass is less than 1,150° C. According to another embodiment of the high-strength alkali-aluminosilicate glass described above, the sink-in-point of the glass is less than 1,100° C.

According to an embodiment of the high-strength alkali-aluminosilicate glass described above, the glass may be used as a protective glass or cover glass. Therefore, according to an embodiment of the high-strength alkali-aluminosilicate glass described above, the glass has a density of up to 2,600 kg/m³ and a linear coefficient of expansion α₂₀₋₃₀₀ 10⁻⁶/K in a range of from 7.5 to 10.5.

According to an embodiment of the high-strength alkali-aluminosilicate glass described above, the glass may be used as a protective glass in applications such as a front (panel) or carrier panel for solar panels, refrigerator doors, and other household products. According to another embodiment of the high-strength alkali-aluminosilicate glass described above, the glass may be used as a protective glass for televisions, as safety glass for automated teller machines, and additional electronic products. According to still another embodiment of the high-strength alkali-aluminosilicate glass described above, the glass may be used as a protective glass for the front or back of cellular telephones. According to yet another embodiment of the high-strength alkali-aluminosilicate glass described above, the glass may be used as a touch screen or touch panel due to its high strength.

### EXAMPLES

The glass compositions set forth below in Table 1 were melted and refined using highly pure raw materials from a mixture in a 2 liter pan, which was heated directly electrically at 1,580° C. The molten mass was then homogenized by means of mechanical agitation.

The molten mass was then processed into bars or cast bodies.

An ion exchange treatment was then conducted in an electrically heated pan salt bath furnace. The process temperature was selected as a function of the respectively measured transformation temperature of the glass ranging from 90 to 120 K below the transformation temperature. The ion exchange treatment times were varied and ranged from 2 to 16 hours.

The measurement of the compressive stress of the surface of the glass and the depth of the compression stress layer (based on double refraction) were determined by using a polarization microscope (Berek compensator) on sections of the glass. The compressive stress of the surface of the glass was calculated from the measured dual refraction assuming a stress-optical constant of 0.26 (nm*cm/N](Scholze, H., Nature, Structure and Properties, Springer-Verlag, 1988, p. 260).

The liquidus temperature of the glass compositions was determined based on the gradient furnace method with a 24 hour residence time of the sample in the furnace. The melting temperature of the glass compositions is designated as “Tₘₑₗₜ”, the working temperature or sink-in point is designated as “T_{work}” and the softening temperature or the Littleton point is designated as “T_{soft}”.

The compositions in terms of the weight percent of each component and results are shown in Table 1 below.

TABLE 1

| | Exam- | Exam- | Exam- | Exam- |
|---|---|---|---|---|
| Component/Result | ple 1 | ple 2 | ple 3 | ple 4 |
| SiO₂ | 66.0 | 65.8 | 62.59 | 63.8 |
| Al₂O₃ | 9.6 | 8 | 11.8 | 11.8 |
| B₂O₃ | 1.8 | 0 | 2.13 | 0.5 |
| MgO | 2.2 | 6.4 | 4.72 | 5.5 |
| CaO | 0.9 | 1.3 | 0 | 0 |
| ZnO | 0 | 0 | 0 | 0 |
| ZrO₂ | 0 | 0 | 0 | 0 |
| Na₂O | 16.8 | 15.9 | 16.14 | 16.34 |
| K₂O | 2.7 | 2.6 | 2.58 | 1.93 |
| Li₂O | 0 | 0 | 0 | 0 |
| Tₘₑₗₜ (10² dPa · s) [° C.] | 1580 | 1595 | 1665 | 1669 |
| T_{work} (10⁴ dPa · s) [° C.] | 1077 | 1070 | 1120 | 1150 |
| T_{soft} (10^{7.6} dPa · s) [° C.] | 720 | 764 | 762 | 785 |
| Liquidus temperature [° C.] | <920 | <850 | <880 | <880 |
| Coefficient of expansion | 9.6 | 10.1 | 8.9 | 8.75 |
| α₂₀₋₃₀₀ [10⁻⁶/K] | | | | |
| Depth of compression stress | 35 | 50 | 45.8 | 48.96 |
| layer [μm] | | | | |
| Compressive stress [MPa] | 385 | 450 | 520 | 515 |

Ion exchange treatment

| | | | | |
|---|---|---|---|---|
| Salt bath temperature [° C.] | 410 | 420 | 450 | 455 |
| Time in salt bath [h] | 4 | 8 | 4 | 4 |

The ion exchange treatment for the glasses of Examples 1-4 was conducted in a 99.8% potassium nitrate salt bath (Ca < 1 ppm).

1. A high-strength alkali-aluminosilicate glass comprising:
from 60.5 to 69.0 weight percent of SiO₂,
from 7.0 to 11.8 weight percent of Al₂O₃,
from 0 to 4.0 weight percent of B₂O₃,
from 2.0 to 8.5 weight percent of MgO,
from 0 to 4.0 weight percent of CaO,
from 0 to 5.0 weight percent ZnO,
from 0 to 3.0 weight percent of ZrO₂,
from 15.0 to 17.5 weight percent of Na₂O,
from 0 to 2.7 weight percent of K₂O,
from 0 to 2.0 weight percent of Li₂O, and
from 0 to 1.5 weight percent of a fining agent selected from As₂O₃, Sb₂O₃, CeO₂, SnO₂, Cl⁻, F⁻, SO₄²⁻, and combinations thereof.

2. The high-strength alkali-aluminosilicate glass according to claim 1, wherein the glass comprises from 0 to 0.5 weight percent of As₂O₃ and Sb₂O₃.

3. The high-strength alkali-aluminosilicate glass according to claim 1, wherein the weight ratio of Al₂O₃ to SiO₂ is from 0.11 to 0.195.

4. The high-strength alkali-aluminosilicate glass according to claim 1, wherein the weight ratio of Na₂O to Al₂O₃ is from 1.2 to 2.2.

5. The high-strength alkali-aluminosilicate glass according to claim 1, wherein the glass comprises from 70 to 81 weight percent of SiO₂, Al₂O₃, and ZrO₂.

6. The high-strength alkali-aluminosilicate glass according to claim 1, wherein the glass comprises from 15.0 to 20.5 weight percent of Na₂O, K₂O, and Li₂O.

7. The high-strength alkali-aluminosilicate glass according to claim 1, wherein the weight ratio of SiO₂, Al₂O₃, and ZrO₂ to Na₂O, K₂O, Li₂O, and B₂O₃ is from 3.3 to 5.4.

8. The high-strength alkali-aluminosilicate glass according to claim 1, wherein the glass comprises from 3.0 to 7.0 or from 4.0 to 6.5 weight percent of MgO.

9. The high-strength alkali-aluminosilicate glass according to claim 1, wherein the glass has a viscosity of <10² dPa·s at 1600° C.

10. The high-strength alkali-aluminosilicate glass according to claim 1, wherein the liquidus temperature of the glass is ≦900° C. or ≦850° C.

11. The high-strength alkali-aluminosilicate glass according to claim 1, wherein the glass has a compressive stress at the surface thereof of at least 350 MPa, at least 450 MPa, up to 600 MPa, or in excess of 650 MPa, and the depth of the compression stress layer is at least 30 μm, at least 50 μm, or up to 100 μm.

12. The high-strength alkali-aluminosilicate glass according to claim 1, wherein the glass has a melting temperature of less than 1,700° C., less than 1,600° C., or less than 1,585° C. at a viscosity of 10² dPa·s.

13. The high-strength alkali-aluminosilicate glass according to claim 1, wherein the glass has a density of less than 2,600 kg/m³, and a linear coefficient of expansion (α₂₀₋₃₀₀ 10⁻⁶/K) of from 7.5 to 10.5.

14. A method for producing a high-strength alkali-aluminosilicate glass, comprising:
a) mixing and melting the components to form a homogenous glass melt comprising:
from 60.5 to 69.0 weight percent of SiO₂,
from 7.0 to 11.8 weight percent of Al₂O₃,
from 0 to 4.0 weight percent of B₂O₃,
from 2.0 to 8.5 weight percent of MgO,
from 0 to 4.0 weight percent of CaO,
from 0 to 5.0 weight percent ZnO,
from 0 to 3.0 weight percent of ZrO₂,
from 15.0 to 17.5 weight percent of Na₂O,
from 0 to 2.7 weight percent of K₂O,
from 0 to 2.0 weight percent of Li₂O, and
from 0 to 1.5 weight percent of a fining agent selected from As₂O₃, Sb₂O₃, CeO₂, SnO₂, Cl⁻, F⁻, SO₄²⁻, and combinations thereof;
b fining the homogenous glass melt;
c) shaping the glass using a down-draw method selected from the overflow down-draw method, the fusion method, the die slot method, the slot down-draw method, and combinations thereof; and
d) chemical strengthening of the glass by ion exchange.

15. The method according to claim 14, wherein the time for the ion exchange treatment is less than 12 hours, less than 6 hours, or less than or equal to 4 hours.

16. The method according to claim 14, wherein the ion exchange treatment takes place at a temperature range of from 50 to 120 K below the transition temperature.

17. The method according to claim 14, wherein the treatment temperature is lowered over the duration of the ion exchange treatment.

18. (canceled)

19. A high-strength alkali-aluminosilicate glass comprising:
from 60.5 to 69.0 weight percent of SiO₂,
from 7.0 to 11.8 weight percent of Al₂O₃,
from 0 to 4.0 weight percent of B₂O₃,
from 2.0 to 8.5 weight percent of MgO,
from 0 to 4.0 weight percent of CaO,
from 0 to 5.0 weight percent ZnO,
from 0 to 3.0 weight percent of ZrO₂,
from 15.0 to 17.5 weight percent of Na₂O,
from 0 to 2.7 weight percent of K₂O,
from 0 to 2.0 weight percent of Li₂O, and
from 0 to 1.5 weight percent of a fining agent selected from As₂O₃, Sb₂O₃, CeO₂, SnO₂, Cl⁻, F⁻, SO₄²⁻, and combinations thereof;
wherein the weight ratio of Al₂O₃ to SiO₂ is from 0.11 to 0.195;
wherein the weight ratio of Na₂O to Al₂O₃ is from 1.2 to 2.2;
wherein the glass comprises from 70 to 81 weight percent of SiO₂, Al₂O₃, and ZrO₂;
wherein the glass comprises from 15.0 to 20.5 weight percent of Na₂O, K₂O, and Li₂O;
wherein the weight ratio of SiO₂, Al₂O₃, and ZrO₂ to Na₂O, K₂O, Li₂O, and B₂O₃ is from 3.3 to 5.4;
wherein the glass comprises from 3.0 to 7.0 MgO;
wherein the glass has a viscosity of <10² dPa·s at 1600° C.;
wherein the liquidus temperature of the glass is ≦900° C. or ≦850° C.;
wherein the glass has a compressive stress at the surface thereof of at least 350 MPa and the depth of the compression stress layer is at least 30 μm;
wherein the glass has a melting temperature of less than 1,700° C. at a viscosity of 10² dPa·s;
wherein the glass has a density of less than 2,600 kg/m³, and a linear coefficient of expansion (α₂₀₋₃₀₀ 10⁻⁶/K) of from 7.5 to 10.5.

20. The high-strength alkali-aluminosilicate glass according to claim 19, wherein the glass comprises from 4.0 to 6.5 weight percent of MgO.

21. The high-strength alkali-aluminosilicate glass according to claim 19, wherein the glass has a compressive stress at the surface thereof of up to 600 MPa and the depth of the compression stress layer is up to 100 μm.
